(19) United States
(12) Patent Application Publication
(10) Pub. No.: US 2009/0057931 A1
(43) Pub. Date: Mar. 5, 2009

(54) Tabletop Humidifier

(76) Inventors: Chi-Hsiang Wang, Taipei (TW); Yung Ming Tai, Tao-Yaun City (TW)

Correspondence Address: FRANCIS EDWARD MARINO, 394 MEREDITH NECK ROAD, MEREDITH, NH, 03253, US

(21) Appl. No.: 11/850,292

(22) Filed: Sep. 5, 2007

(51) Int. Cl. B05B 17/04

(52) U.S. Cl. 261/72.1; 261/84

(57) ABSTRACT

A tabletop humidifier is disclosed which embodies one or more of low voltage operation from a high voltage supply through a current-limited transformer to provide a safely limited shock risk proximate to its water containing areas, tool-free and uncomplicated disassembly to enable end-of-life recycling of its components, and improved humidification efficiency through an inexpensive and reliable by-pass preventing means.

### FIELD OF THE INVENTION

This invention relates to tabletop household humidifiers, and more specifically, to safety, environmental, and performance improvements thereto.

### BACKGROUND OF THE INVENTION

Numerous prior art tabletop household humidifiers use fans to cause moistened air to flow from the interior of the humidifier to the outside environment. Often, such humidifiers have an open basin disposed below the fan for holding water and have humidification means, such a wicking pads, disposed in or above the water and between the water and the fan for causing the causing the water to be vaporized into the air stream.

For simplicity and economy, prior art humidifiers have been manufactured to operate at 120VAC, and the fan motors have had a 120VAC input rating. Humidifiers are generally plugged into and operated from normal 120VAC wall outlets, which typically connect through fuses or circuit breakers ranging from a 15 Amp to a 30 Amp rating. The risks of having such a high power source proximate to an open water reservoir are obvious, yet there are no legal or code requirements which dictate the use of such humidifiers from GFCI-served power outlets, so such prior art humidifiers are, at the least, the cause of significant anxiety to cautious users, and at the worst, a significant shock hazard.

Recent trends in environmental consciousness, together with the unreliability of polymer supplies and the rising cost of such polymers when supplies are steady, have combined to make the recycling of plastic components a common practice, and even a requirement in many areas. Plastic components are now marked with material identifiers and recycling codes to enable sorting for recycling. Most US household now have some degree of recycling means, such as bins into which trash and other items for disposal are sorted according to the material with which they were made, and for plastics, according to their recycling codes.

UL 998, for Household Humidifiers (UL 998) is the safety standard to which all 120VAC tabletop household humidifiers must adhere, under US law. UL 998 defines an “extra-low-voltage circuit” as “a circuit that has a potential of not more than 30 volts DC and supplied by a Class 2 transformer”, and defines a “hazardous circuit” as “a circuit having characteristics in excess of those of an extra-low-voltage circuit”. Among other things, UL 998 requires extra-ordinary steps, such as the use of tools or complicated disassembly techniques to disassemble housings when such disassembly would expose one to hazardous circuits. Such a requirement has been a roadblock to recycling efforts, because many otherwise willing consumers are incapable of disassembling items which require such tool use or complicated techniques.

UL safety standards do not have such stringent disassembly requirements for extra-low-voltage circuits. For example, an appliance which operates at a low DC voltage through a plug-in AC to DC transformer needs only to adhere, for disassembly requirements, to the requirements for Class 2 transformers. As such, the live-part inaccessibility requirements and complicated disassembly techniques are not a requirement for extra-low-voltage appliances.

Prior art evaporative humidifiers of the wicking pad type are characterized by a wicking pad which rests in the aforementioned water basin. The wicking pad is water-absorbent and porous to airflow. The pad draws water up from the basin through capillary action to soak the pad, and the aforementioned fan pulls dry air from outside of the humidifier, through the soaked pad to cause evaporation and moisten the air stream, then forces the moistened air from the humidifier to humidify the surrounding air.

For optimal performance, all airflow within the humidifier should be forced through the soaked pad. The top of the wicking pad should be sealed to prevent unmoistened air from bypassing the moistened pad, which would then decrease the humidifier's humidification efficiency.

A common impedance to proper sealing of the top of wicking pads in such humidifiers is the slouching of the pad as it becomes soaked. Such pads are generally made of paper. The weight of the water as it absorbs, coupled with its poor structural integrity, causes the top surface of the wicking pad to droop away from the seals of prior art humidifiers, thereby allowing a by-pass pathway over the wicking pad and decreasing humidification efficiency.

Numerous attempts have been made to minimize such slouching, particularly by adding support to the pads in an attempt to help the pads to hold their shape when soaked. For instance, U.S. Pat. No. 6,110,564 teaches the addition of a rigid non-wicking paper layer within the pad to support the pad as it absorbs water. U.S. Pat. No. 5,374,381 teaches the addition of a rigid expanded aluminum layer within the pad to support the pad as it absorbs water. But such techniques add expense to the pad, which is a consumable item that is often replaced over the life of the humidifier, thereby forcing the consumer to repeatedly pay that expense each time a pad is replaced.

Alternative means and methods have been employed, in the form of elaborate and expensive external support structures for the wick pads, but such have not only been expensive and cumbersome, but are found to be ineffective due in large part to the inconsistency of the shape of such paper wick pads and the unpredictability of each particular wick pad's slouching of any given wick.

### OBJECTS OF THE INVENTION

There exists the need for a tabletop household humidifier which reduces consumer anxiety with respect to shock hazards, and such is an object of the present invention.

There exists the need for a tabletop household humidifier which increases safety by reducing user exposure to electrical shock and reducing the level of electrical shock, and such are objects of the present invention.

There exists the need for a tabletop household humidifier which enables end-of-life recycling of its components, and such is an object of the present invention.

There exists the need for a tabletop household humidifier which eliminates airflow bypass in an economical and reliable manner, and such is an object of the present invention.

### SUMMARY OF THE INVENTION

The present invention is a humidifier which embodies one or more of the following features;
1. Low voltage operation from a high voltage supply through a current-limited transformer to provide a safely limited shock risk proximate to its water containing areas.
2. Tool-free and uncomplicated disassembly to enable end-of-life recycling of its components.
3. Improved humidification efficiency through an inexpensive and reliable by-pass preventing means.

Many aspects of the invention can be better understood with reference to the following detailed description of an exemplary humidifier according to the invention along with accompanying drawings. The components in the drawings are not necessarily to scale, emphasis instead being placed upon clearly illustrating the principles of the invention. Moreover, in the drawings, like reference numerals designate corresponding parts throughout the several views.

### BRIEF DESCRIPTION OF THE DRAWINGS

FIG. 1 is a perspective view of an exemplary humidifier according to a preferred embodiment of the invention.

FIG. 2 is a perspective view of the humidifier of FIG. 1 showing removal of the top cover assembly for access to the internal chamber,

FIG. 3 is an exploded view of the humidifier of FIG. 1 showing its disassembled state,

FIG. 4 is a cross-sectional side view of the humidifier of FIG. 1,

FIG. 5 is a partial close-up view of the humidifier of FIG. 1 showing the disassembly of the control panel from the top housing,

FIG. 6A is a broken perspective view of the top cover assembly, flipped over, of the humidifier of FIG. 1, and

FIG. 6B is a partial cross sectional view along line 6B-6B of FIG. 6A, showing the disassembly of the adjustable sleeve from the top housing.

### DETAILED DESCRIPTION OF THE INVENTION

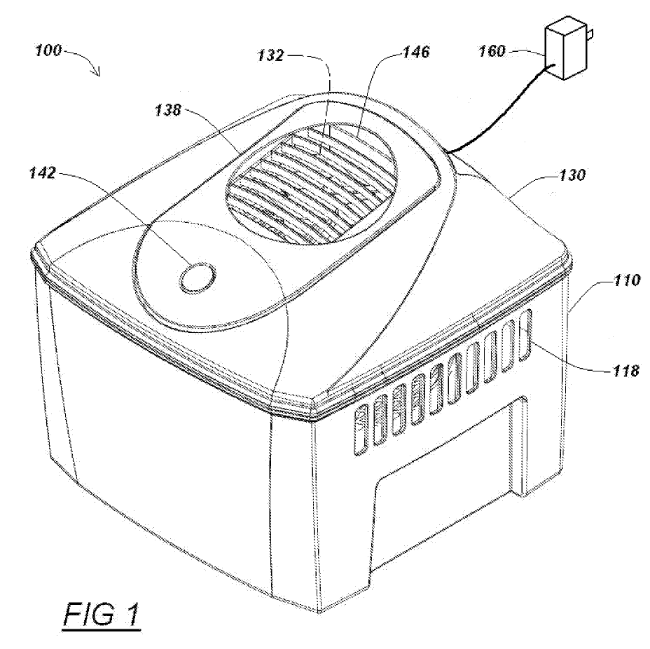

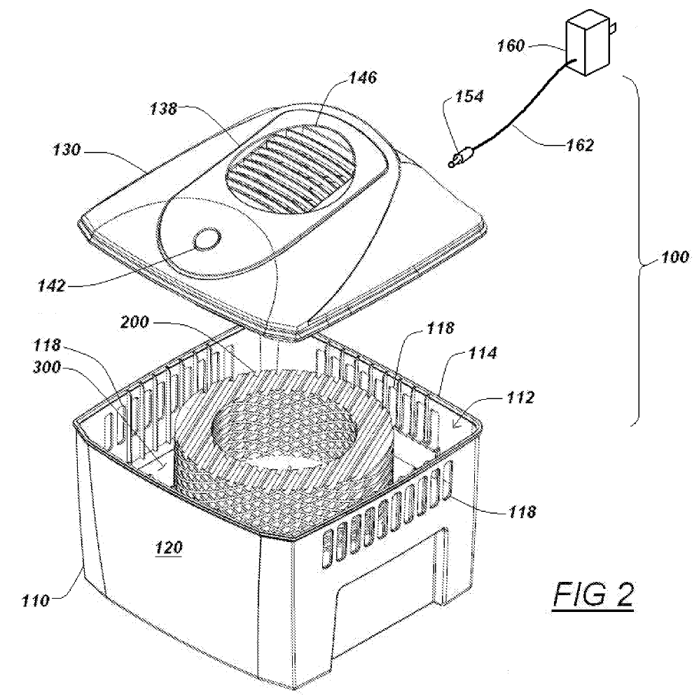

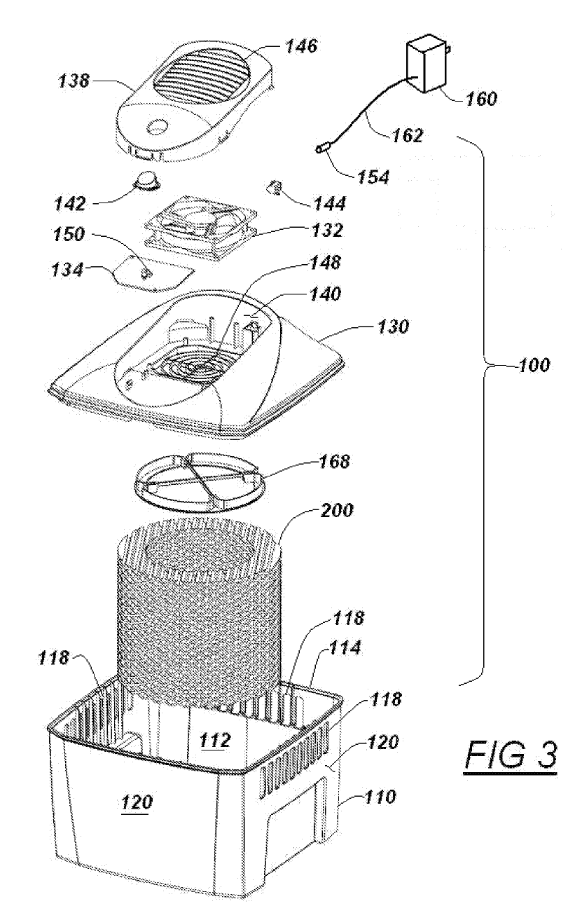

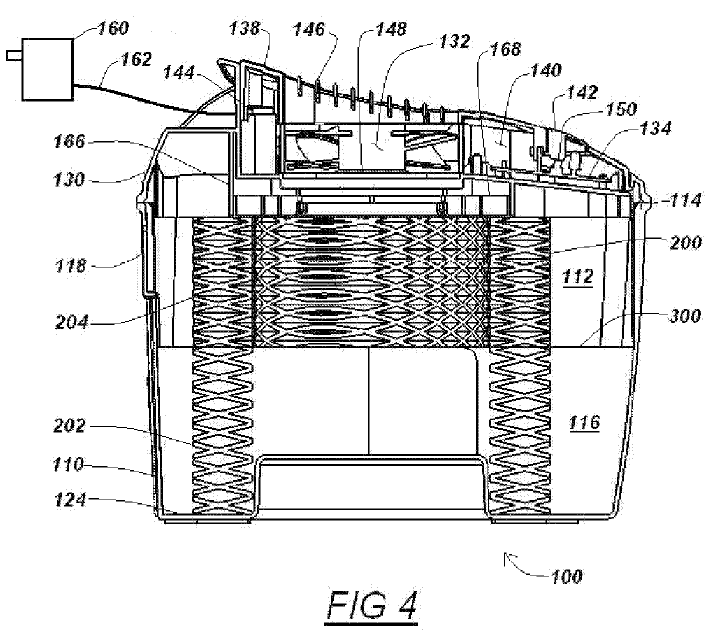

Referring to FIGS. 1 though 6B, there is shown an exemplary tabletop humidifier 100 according to a preferred embodiment of the invention. Humidifier 100 includes lower basin 110 having a hollow interior chamber 112 and an open peripheral top edge 114. The lower portion of the basin forms a reservoir 116 for receiving water 200 to be evaporated. Intake grills 118 are disposed about the basin's horizontal peripheral walls 120 above water 300.

Cylindrical wicking pad 200 is disposed within interior chamber 112, resting on the basin's bottom wall 124 and partially submerged in water 300. Pad 200 may be made of a laminated assembly of expanded sheets of absorbent paper, according to well-known techniques and construction, such as those disclosed in U.S. Pat. Nos. 5,374,381 and 6,110,564, the specifications of which are incorporated herein by reference.

Absorbent pad 200 is comprised of lower portion 202 and upper portion 204. Lower portion 202 is adapted to absorb water from the reservoir, which rises to soak upper portion 204 via capillary rise. Upper portion 204 is porous and thereby adapted to allow horizontal airflow there-through.

Top cover 130 rests atop the basin's open peripheral top edge 114 to enclose interior chamber 112. Top cover 130 houses motorized fan 132 and control circuit board 134 and thereby serves as a fan housing, a control housing, and a lid. Motorized fan 132 is a 12V DC motor-driven axial blower such as that disclosed in U.S. Pat. No. 6,416,300 the specification of which is incorporated herein by reference.

Control cover 138 is affixed to fan pocket 140 in top cover 130 to capture there-between the motorized fan 132, the circuit board 134, control button 142, and input jack 144. Control cover 138 includes fan exhaust grill 146, which is disposed above fan 132. Fan pocket 140 includes fan intake grill 148, which is disposed below fan 132. In total, the circuitry of the humidifier including its fan motor consumes a mere 80 mA of current at 12 VDC.

Control button 142 cooperates with control switch 150 on circuit board 134 to activate various functions of the humidifier, such as high speed and low speed operation. Input jack 144 is electrically connected circuit board 134 and in shaped and arranged to receive output jack 154 of transformer assembly 160 to provide power to the circuit board. Transformer assembly 160 has in input rating of 120VAC and an output rating of 12VDC at 100 mA. Transformer 160 is a plug-in type transformer for affixing directly to a wall outlet and isolates the high 120VAC voltage of the municipal supply from the humidifier, while being adapted for remote positioning from the humidifier via extension cord 162. Output jack 154 may be unplugged from input jack 144 when humidifier 100 is carried to a sink for refilling, thereby leaving all high-voltage components safely away from the water supply.

Extension cord 162 is preferably thirty-six inches or more long. Because current electrical codes require spacing between AC wall outlets of six feet or less, such an extension cord length allows the humidifier to always reach properly spaced power outlets and thereby discourages the use of auxiliary extension cords. By so discouraging such use, transformer 160 is more likely to be affixed directly to the wall outlet and thereby less likely to come in contact with spilled water or fall into the humidifier while energized.

Telescoping sleeve 164 is positioned around fan intake grill 148 and comprises stationary cylindrical outer sleeve 166, which depends downwardly from top cover 130 towards wicking pad 200, and floating cylindrical inner sleeve 168 which is adapted for vertical movement relative to and coaxially with outer sleeve 166 so that the lower circular edge 170 of inner sleeve 168 rests upon the upper circular surface 206 of wicking pad 200.

During operation, dry air is pulled into the basin's interior chamber 112 through basin intake grills 118 under the force of motorized fan 132, and caused to pass through soaked upper portion 204 of pad 200 to become moistened air, then forced through fan exhaust grill 146 to the outside of the humidifier to humidify the surrounding environment.

Paper wicking pads of the type of this disclosure are prone to slouch as they absorb water and become soaked. This usually results in unpredictable drop of their circular top surface, which would otherwise create a gap between that top surface and the underside of the top housing. Such a gap would allow dry air to bypass the soaked wick and would lead to humidification inefficiencies. It should be appreciated that the vertical floating feature of inner sleeve 168, allow it to always extend down to rest upon circular top surface 206, despite changes to the vertical positioning of surface 206, thereby preventing such undesirable bypass airflow.

Basin 110 and control button 142 are preferably made of polypropylene. Top cover 130, control cover 138, and inner sleeve 168 are preferable made of ABS. In order to simplify recycling of these various plastics, it is a feature of this humidifier that each of these components is easily disassembled from the others with no need for tools or complicated disassembly procedures. Such a feature is only practical because the circuitry exposed during disassembly is low voltage, thereby preventing the need for the use of tools or complicated disassembly techniques for safety approval.

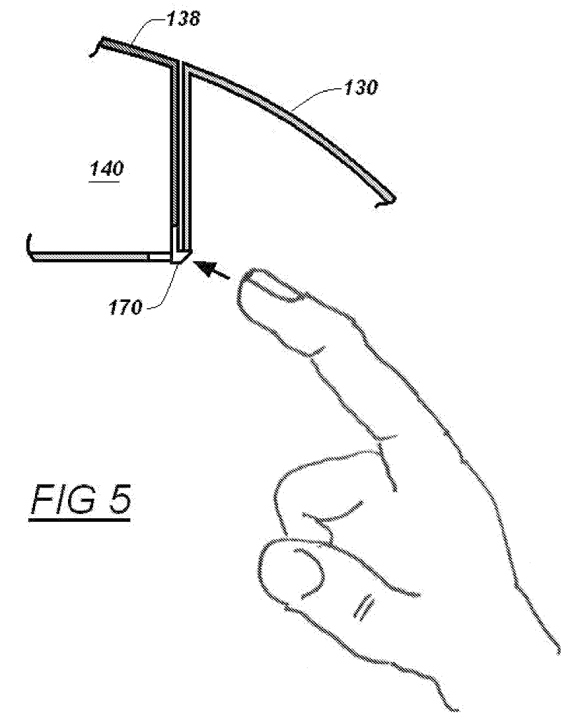

Referring to FIG. 5, it can be seen that flex hooks 170 of control cover 138 need only be pushed inwardly in a simply singular motion to enable separation of control cover 138 from top cover 130. Such separation frees fan 132, circuit board 134, button 142, and input jack 144, which had been sandwiched between covers 138 and 130, so that the various components may be easily sorted and properly recycled. Each plastic component may be clearly marks on in internal and previously invisible surface with its proper recycling code.

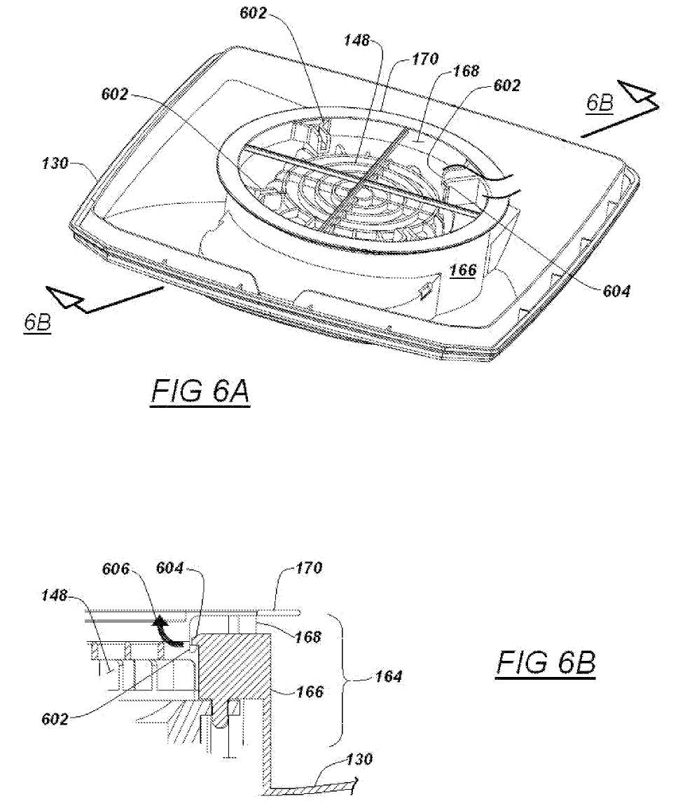

Separation of inner sleeve 168 from top cover 130 for cleaning and recycling is best understood in view of FIGS. 6A and 6B. Inner sleeve includes four receptors 602 which are engaged by four mating clips 604 of outer sleeve 166. The engagement of clips 604 and receptors 604 allows relative vertical movement of the inner and outer sleeve, but prevents inadvertent separation. As shown by arrow 606 in FIG. 6B, removal of inner sleeve 168 from outer sleeve 166 is accomplished by flexing all four receptors 602 inwardly and away from clips 602, and lifting inner sleeve 168 away from the top cover 130.

In summary the invention may include a tabletop humidifier as exemplified by the above-described embodiment with a basin forming a reservoir for holding water, a fan housing disposed atop the basin and including a motorized fan having an operating voltage at or below approximately twenty-four volts; and a transformer disposed remotely from the basin and the fan housing and adapted to convert a high voltage input from a power supply into an output equal to the operating voltage and connected to the motorized fan, wherein the high voltage input may be at or above approximately ninety volts.

Additionally, the transformer may be is a plug-in transformer adapted for affixation directly to a power supply wall socket and the input may be between approximately ninety and approximately one-hundred-twenty-five volts AC, and the output may be at or less than approximately thirteen volts DC.

The humidifier may have a porous wicking pad within the basin for drawing water upwardly from the reservoir to become dampened, wherein the motorized fan causes dry air to flow from a surrounding environment into the basin and through the dampened wicking pad to become moistened air, and causes the moistened air to flow from the basin to the surrounding environment to humidify the surrounding environment.

The wicking pad may extend upwardly from the reservoir to contact an undersurface of the fan housing and the moistened air may flow from the basin through the fan housing to the surrounding environment.

The fan housing may include a plurality of housing components for containing the motorized fan, and the components may be adapted for tool-free disassembly.

Alternatively, the invention may include a tabletop humidifier as exemplified by the above-described embodiment having a fan housing including a motorized fan having an operating voltage at or below approximately twenty-four volts, and a transformer disposed remotely from the fan housing and adapted to convert a high voltage input from a power supply into an output equal to the operating voltage and connected to the motorized fan, wherein the high voltage input is at or above approximately ninety volts.

The fan housing of this humidifier may include a plurality of housing components for containing the motorized fan, and the components may be adapted for tool-free disassembly.

The transformer of this humidifier may a plug-in transformer adapted for affixation directly to a power supply wall socket, and the input may be between approximately ninety and approximately one-hundred-twenty-five volts AC, and the output may be at or less than approximately thirteen volts DC.

This humidifier may have a basin disposed below the fan housing with a porous wicking pad there-in for drawing water upwardly from the reservoir to become dampened, wherein the motorized fan causes dry air to flow from a surrounding environment into the basin and through the dampened wicking pad to become moistened air, and causes the moistened air to flow from the basin to the surrounding environment to humidify the surrounding environment.

The wicking pad of this humidifier may extend upwardly from the reservoir to contact an undersurface of the fan housing, and the moistened air may flow from the basin through the fan housing to the surrounding environment.

Alternatively, the invention may include a tabletop humidifier as exemplified by the above-described embodiment having a basin forming a reservoir for holding water, a fan housing disposed atop the basin and including a motorized fan, a porous wicking pad within the basin and extending upwardly from the reservoir toward the fan housing for drawing water upwardly from the reservoir to become dampened, and a coupling depending downwardly from the fan housing towards a top surface of the wicking pad wherein the wicking pad is prone to height modification as it becomes dampened thereby altering the horizontal disposition of the top surface, and the coupling is adapted for vertical self adjustment to follow the height modifications and to thereby always rest on the top surface, wherein the motorized fan causes dry air to flow from a surrounding environment into the basin and through the dampened wicking pad to become moistened air, and causes the moistened air to flow from the basin to the surrounding environment to humidify the surrounding environment, and wherein the coupling prevents air from flowing from the surrounding environment into the basin and from the basin except through the dampened wicking pad.

The wicking pad of this humidifier may be a vertically disposed cylinder having a hollow interior chamber and a circular top surface, the motorized fan may be disposed over the chamber, and the coupling may be a telescoping cylindrical sleeve extending down from around the motorized fan to the circular top surface.

The motorized fan of this humidifier may have an operating voltage at or below approximately twenty-four volts; and the humidifier may employ a transformer disposed remotely from the basin and the fan housing and adapted to convert a high voltage input from a power supply into an output equal to the operating voltage and connected to the motorized fan, wherein the high voltage input is at or above approximately ninety volts. The transformer may be a plug-in transformer adapted for affixation directly to a power supply wall socket.

From the foregoing, it will be clear that the present invention has been shown and described with reference to a preferred embodiment that merely exemplifies the broader invention revealed herein. Certainly, those skilled in the art can conceive of alternative embodiments. For instance, those with the major features of the invention in mind could craft embodiments that incorporate one or more major features while not incorporating all aspects of the foregoing exemplary embodiment.

With this in mind, the claims that follow will define the scope of protection to be afforded the invention, and those claims shall be deemed to include equivalent constructions insofar as they do not depart from the spirit and scope of the present invention. Certain of these claims may express certain elements as a means for performing a specific function, at times without the recital of structure or material. As the law demands, any such claims shall be construed to cover not only the corresponding structure and material expressly described in the specification but also equivalents thereof.

We claim:

1. A tabletop humidifier comprising;
a basin having a reservoir for holding water;
a fan housing disposed atop said basin and comprising a motorized fan having an operating voltage at or below approximately twenty-four volts; and
a transformer disposed remotely from said basin and said fan housing and adapted to convert a high voltage input from a power supply into an output equal to said operating voltage and connected to said motorized fan, wherein
said high voltage input is at or above approximately ninety volts.

2. The tabletop humidifier of claim 1 wherein said transformer is a plug-in transformer adapted for affixation directly to a power supply wall socket.

3. The tabletop humidifier of claim 2 wherein said input is between ninety and one-hundred-twenty-five volts AC, and said output is at or less than approximately thirteen volts DC.

4. The tabletop humidifier of claim 3 further comprising a porous wicking pad within said basin for drawing water upwardly from said reservoir to become dampened, wherein said motorized fan causes dry air to flow from a surrounding environment into said basin and through said dampened wicking pad to become moistened air, and causes said moistened air to flow from said basin to the surrounding environment to humidify the surrounding environment.

5. The tabletop humidifier of claim 4 wherein said wicking pad extends upwardly from said reservoir to contact an undersurface of said fan housing.

6. The tabletop humidifier of claim 5 wherein said moistened air flows from said basin through said fan housing to said surrounding environment.

7. The tabletop humidifier of claim 3 wherein said fan housing comprises a plurality of housing components for containing said motorized fan, and said components are adapted for tool-free disassembly.

8. The tabletop humidifier of claim 7 further comprising a porous wicking pad for drawing water upwardly from said reservoir to become dampened, wherein said motorized fan causes dry air to flow from a surrounding environment into said basin and through said dampened wicking pad to become moistened air, and causes said moistened air to flow from said basin to the surrounding environment to humidify the surrounding environment.

9. The tabletop humidifier of claim 8 wherein said wicking pad extends upwardly from said reservoir to contact an undersurface of said fan housing.

10. The tabletop humidifier of claim 9 wherein said moistened air flows from said basin through said fan housing to said surrounding environment.

11. A tabletop humidifier comprising;
a fan housing comprising a motorized fan having an operating voltage at or below approximately twenty-four volts; and
a transformer disposed remotely from said fan housing and adapted to convert a high voltage input from a power supply into an output equal to said operating voltage and connected to said motorized fan, wherein
said high voltage input is at or above approximately ninety volts.
wherein said fan housing comprises a plurality of housing components for containing said motorized fan, and said components are adapted for tool-free disassembly.

12. The tabletop humidifier of claim 11 wherein said transformer is a plug-in transformer adapted for affixation directly to a power supply wall socket.

13. The tabletop humidifier of claim 12 wherein said input is between approximately ninety and approximately one-hundred-twenty-five volts AC, and said output is at or less than approximately thirteen volts DC.

14. The tabletop humidifier of claim 13 further comprising a basin disposed below said fan housing and having a porous wicking pad there-within for drawing water upwardly from said reservoir to become dampened, wherein said motorized fan causes dry air to flow from a surrounding environment into said basin and through said dampened wicking pad to become moistened air, and causes said moistened air to flow from said basin to the surrounding environment to humidify the surrounding environment.

15. The tabletop humidifier of claim 14 wherein said wicking pad extends upwardly from said reservoir to contact an undersurface of said fan housing.

16. The tabletop humidifier of claim 15 wherein said moistened air flows from said basin through said fan housing to said surrounding environment.

17. A tabletop humidifier comprising;
a basin having a reservoir for holding water;
a fan housing disposed atop said basin and comprising a motorized fan;
a porous wicking pad within said basin and extending upwardly from said reservoir toward said fan housing for drawing water upwardly from said reservoir to become dampened; and
a coupling depending downwardly from said fan housing towards a top surface of said wicking pad;
wherein said wicking pad is prone to height modification as it becomes dampened, thereby altering the horizontal disposition of said top surface, and said coupling is adapted for vertical self adjustment to follow said height modifications and to thereby always rest on said top surface;
wherein said motorized fan causes dry air to flow from a surrounding environment into said basin and through said dampened wicking pad to become moistened air, and causes said moistened air to flow from said basin to the surrounding environment to humidify the surrounding environment; and
wherein said coupling prevents air from flowing from said surrounding environment into said basin and from said basin except through said dampened wicking pad.

18. The tabletop humidifier of claim 17 wherein:
said wicking pad is a vertically disposed cylinder having a hollow interior chamber and a circular top surface;
said motorized fan is disposed over said chamber; and
said coupling is a telescoping cylindrical sleeve extending down from around said motorized fan to said circular top surface.

19. The humidifier of claim 18 wherein said motorized fan has an operating voltage at or below approximately twenty-four volts, and said humidifier further comprises a transformer disposed remotely from said basin and said fan housing and is adapted to convert a high voltage input from a power supply into an output equal to said operating voltage and connected to said motorized fan, and wherein said high voltage input is at or above approximately ninety volts.

20. The tabletop humidifier of claim 19 wherein said transformer is a plug-in transformer adapted for affixation directly to a power supply wall socket.
